(19) United States
(12) Patent Application Publication
(10) Pub. No.: US 2014/0111530 A1
(43) Pub. Date: Apr. 24, 2014

(54) APPARATUS AND METHOD FOR BUFFERING SIGNAL DELAY BETWEEN DISPLAY DEVICE IN MULTI-DISPLAY ENVIRONMENT

(71) Applicant: Orion Co., Ltd., Gyeongsangbuk-do (KR)

(72) Inventor: Su Sam Choi, Gyeonggi-do (KR)

(73) Assignee: Orion Co., Ltd., Gyeongsangbuk-do (KR)

(21) Appl. No.: 14/054,462

(22) Filed: Oct. 15, 2013

(30) Foreign Application Priority Data
Oct. 22, 2012 (KR) 10-2012-0117146

(51) Int. Cl. G06F 12/00

(52) U.S. Cl. CPC G06F 12/00
USPC 345/545

(57) ABSTRACT

An apparatus for buffering a signal delay between display devices in a multi-display environment includes: a delay setting unit for storing a delay time value and providing the delay time value to a signal input controller; a storage unit for storing and outputting an image signal according to the control of the signal input controller; and the signal input controller for controlling an input of an image signal from an image processor to a display module, the signal input controller controlling the image signal input from the image processor to be stored in the storage unit and then input to the display module after a delay as much as the delay time value. Since an image signal input time difference of all display devices is buffered to offset a display time difference of the display devices, it is possible to prevent image quality from deteriorating.

### CROSS-REFERENCE TO RELATED APPLICATION

This application claims priority to Korean Patent Application No. 10-2012-0117146, filed on Oct. 22, 2012, and all the benefits accruing therefrom under 35 U.S.C. §119, the contents of which in its entirety are herein incorporated by reference.

### BACKGROUND

1. Field

The present disclosure relates to buffering a signal delay between display devices in a multi-display environment, and more particularly, to an apparatus and method for buffering a signal delay between display devices in a multi-display environment, which prevents image quality from deteriorating due to a display time difference between display devices by buffering an image signal input time difference between the display devices in a multi-display environment where a display screen is implemented using a plurality of display devices.

2. Description of the Related Art

In order to overcome a configuration limit of a display device, a multi-display device implementing a display screen using a plurality of display devices is being developed.

The multi-display device may configure a display screen in various ways depending on size and arrangement of display devices. For example, a large multi-display device configuring a display screen by combining several 42-inch display devices in a rectangular arrangement may be installed at home, hospitals, public offices, airports or the like.

An image output time of each display device varies according to extension and contraction of an image in the multi-display environment, image transmission using daisy-chain, and scaling of the image. In this case, even though an image in the multi-display device operates like a single screen, the display devices actually display images at different timings.

Such an image display time difference of display devices causes several problems. In a still image, as shown in FIG. 1, a contour of a vertical scroll bar image 15 over a boundary surface of each display device 10 is gentle and natural. However, in a moving picture, as shown in FIG. 2, if an image moves along a boundary surface between display devices 20, contours of images over the boundary surface are not naturally connected, but a contour of a vertical scroll bar image 25 is twisted as much as a display time difference of the display devices 20. This phenomenon is more serious when an image moves faster, which deteriorates a quality of the image displayed by the multi-display device.

In addition, due to the display time difference of display devices, as shown in FIG. 3, if a line of vision of a person fixed at a screen 27 of a display device moves to a screen 28 of another display device, since light output periods through a screen are not matched, an optical illusion by which a boundary surface 30 is seen instantly brightly or darkly is caused, which deteriorates a quality of the image displayed by the multi-display device.

In addition, when photographing an image displayed on the screen of the corresponding multi-display device with an imaging device such as a camera or a broadcasting camera, the photographed image is not regular due to the display time difference of the display devices.

### SUMMARY

The present disclosure is directed to providing an apparatus and method for buffering a signal delay between display devices in a multi-display environment, which may prevent image quality from deteriorating due to a display time difference between display devices by buffering an image signal input time difference between the display devices in a multi-display environment where a display screen is implemented using a plurality of display devices.

In one aspect, there is provided an apparatus for buffering a signal delay between display devices in a multi-display environment, which buffers an image signal input time difference of display devices with respect to a display module in a multi-display environment where a display screen is implemented using a plurality of display devices, the apparatus including: a delay setting unit for storing a delay time value and providing the delay time value to a signal input controller; a storage unit for storing and outputting an image signal according to the control of the signal input controller; and a signal input controller for controlling an input of an image signal from an image processor to a display module, the signal input controller controlling the image signal input from the image processor to be stored in the storage unit and then input to the display module after a delay as much as the delay time value.

In the apparatus for buffering a signal delay between display devices in a multi-display environment according to the present disclosure, the storage unit may be a volatile memory including a synchronous dynamic random access memory (SDRAM).

In addition, in the apparatus for buffering a signal delay between display devices in a multi-display environment according to the present disclosure, the delay setting unit may store the delay time value in a table form including configuration information (M×N) of the entire multi-display device, an identifier (ID) for identifying a location of a display device belonging thereto, and a time delay value of the corresponding display device.

Moreover, in the apparatus for buffering a signal delay between display devices in a multi-display environment according to the present disclosure, the signal input controller may read a corresponding delay time value from the delay setting unit based on the configuration information (M×N) of the entire multi-display device and the identifier (ID) for identifying a location of a display device belonging thereto, included in the control signal input to the image processor, and delay the image signal as much as the corresponding time delay value.

In addition, in the apparatus for buffering a signal delay between display devices in a multi-display environment according to the present disclosure, after measuring a time difference between a vertical synchronization signal of an original image input to each display device and a vertical synchronization signal input to each display module, then comparing the time difference with a time difference of a display module having the greatest time difference, the delay time value may be set as a difference between the time difference of each display module and the greatest time difference.

Moreover, in the apparatus for buffering a signal delay between display devices in a multi-display environment according to the present disclosure, after measuring a time difference between a vertical synchronization signal of an original image input to each display device and a vertical synchronization signal input to each display module, the delay time value may be set as a value obtained by subtracting the measured value from an interval of the vertical synchronization signal of the original image.

In addition, in the apparatus for buffering a signal delay between display devices in a multi-display environment according to the present disclosure, when a time difference between a vertical synchronization signal of an original image input to the plurality of display devices and a vertical synchronization signal input to each display module has a regular pattern, the regular pattern may be calculated and compared with a time difference of a display module having the greatest time difference, and the delay time value may be set as a difference between the time difference of each display module and the greatest time difference.

Moreover, in the apparatus for buffering a signal delay between display devices in a multi-display environment according to the present disclosure, when a time difference between a vertical synchronization signal of an original image input to the plurality of display devices and a vertical synchronization signal input to each display module has a regular pattern, the regular pattern may be calculated, and the delay time value may be set as a value obtained by subtracting the calculated value from an interval of the vertical synchronization signal of the original image.

In another aspect, there is provided a method for buffering a signal delay between display devices in a multi-display environment, which buffers an image signal input time difference of display devices with respect to a display module in a multi-display environment where a display screen is implemented using a plurality of display devices, the method including: controlling, by a signal input controller, an image signal input from an image processor to be stored in a storage unit; checking, by the signal input controller, whether a delay time set in a delay setting unit has passed; and reading, by the signal input controller, the image signal stored in the storage unit and outputting the image signal to a display module when the delay time has passed.

In the method for buffering a signal delay between display devices in a multi-display environment according to the present disclosure, the checking of whether a delay time set in a delay setting unit has passed may include: checking, by the signal input controller, configuration information (MEN) of the entire multi-display device and an identifier (ID) set to identify a location of a display device belonging thereto, included in a control signal input to the image processor; and reading, by the signal input controller, a delay time value corresponding to the configuration information (M×N) and the identifier (ID) from the delay setting unit.

According to the present disclosure, since an image signal input time difference between display devices is buffered to offset a signal delay between the display devices in a multi-display environment where a display screen is implemented using a plurality of display devices, it is possible to prevent image quality from deteriorating due to the display time difference between display devices.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIGS. 1 to 3 are diagrams for illustrating a screen display phenomenon caused by a screen display time difference in a multi-display environment;

FIG. 4 is a diagram showing an apparatus for buffering a signal delay between display devices in a multi-display environment according to the present disclosure;

FIG. 5 is a diagram showing a multi-display screen for illustrating that a signal delay between display devices is buffered in a multi-display environment according to the present disclosure;

FIG. 6 is a diagram showing a timing of a vertical synchronization signal input to a module of each display device in order to illustrate a signal input time difference between display devices and a signal input delay in a multi-display environment according to the present disclosure; and

FIG. 7 is a diagram for illustrating a method for buffering a signal delay between display devices in a multi-display environment according to the present disclosure.

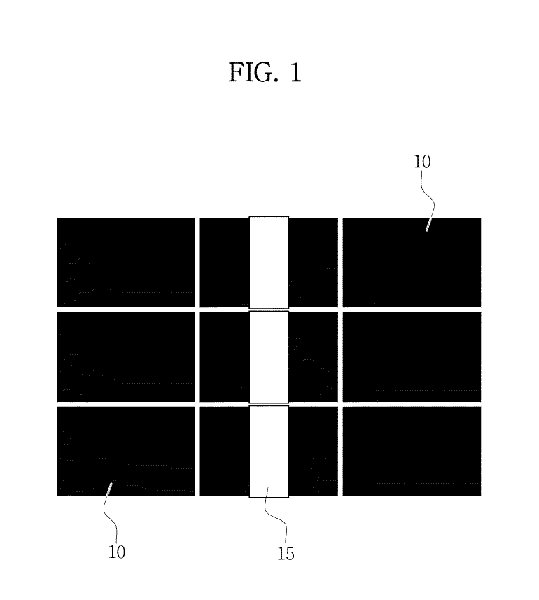

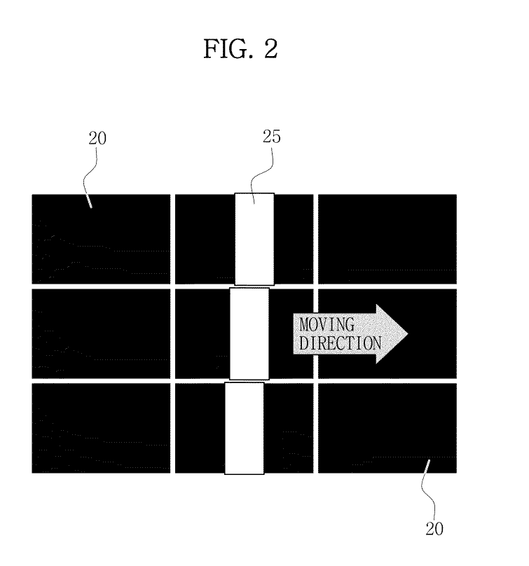

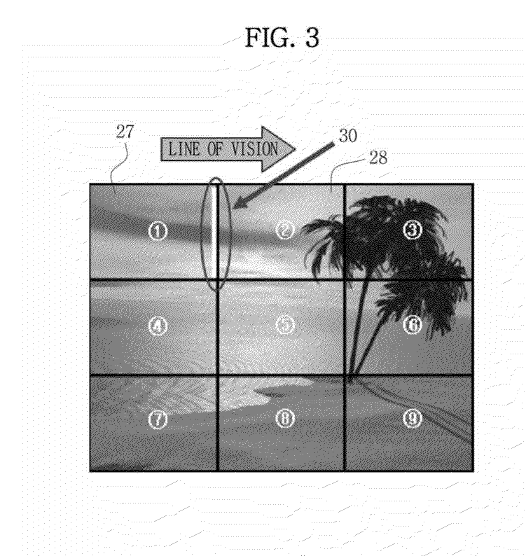

### DETAILED DESCRIPTION

Hereinafter, an embodiment of the present disclosure will be described with reference to the accompanying drawings. Even though the present disclosure is described with reference to the embodiment depicted in the drawings, this is just an example, and the spirit, essence and operations of the present disclosure are not limited thereto.

The present disclosure is implemented to store an image signal input to a display module provided at each display device of a multi-display device in a storage unit and input the image signal to a display module after a delay so as to synchronize image signals input to display modules so that image signals are input to all display modules without a time difference and thus all display modules may display images simultaneously on a screen without a time difference.

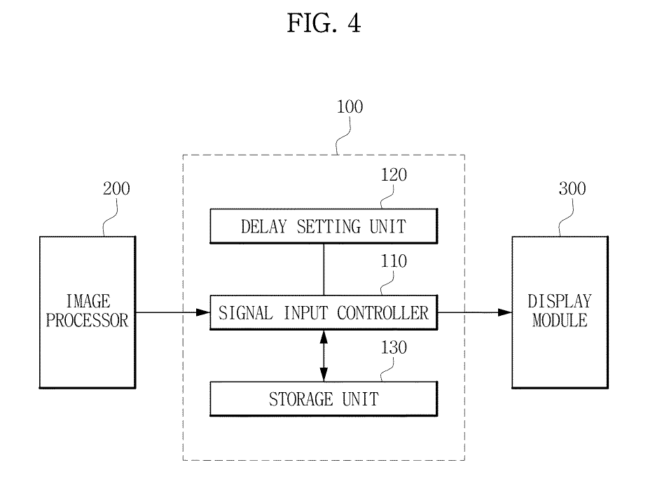

For this, an apparatus 100 for buffering a signal delay between display devices in a multi-display environment according to the present disclosure includes a signal input controller 110, a delay setting unit 120 and a storage unit 130, as shown in FIG. 4.

An image processor 200 is provided at each display device of the multi-display device and functions to process and output an image signal, which includes an RGN signal, a vertical synchronization signal and a horizontal synchronization signal input from the outside, according to a control signal including configuration of the entire multi-display device and location information of displays belonging thereto. In addition, a display module 300 is provided at each display device of the multi-display device and functions to operate according to the input image signal and display an image on a screen.

The signal input controller 110 controls an input of an image signal from the image processor 200 to the display module 300. The signal input controller 110 stores an image signal input from the image processor 200 in the storage unit 130 and outputs the image signal to the display module 300 after a delay. At this time, the signal input controller 110 delays the image signal as much as a delay time value set in the delay setting unit 120 and then outputs the image signal to the display module 300.

The delay setting unit 120 stores a preset delay time value and provides the corresponding delay time value to the signal input controller 110.

The storage unit 130 stores and outputs an image signal according to the control of the signal input controller 110. Here, the storage unit 130 stores the image signal input from the signal input controller 110 according to the control of the signal input controller 110 and outputs the image signal to the signal input controller 110. The storage unit 130 may be implemented with a memory element, specifically with a volatile memory such as a synchronous dynamic random access memory (SDRAM) since an input image signal should be written or read faster than its frequency.

The apparatus 100 for buffering a signal delay between display devices as described above is provided at each display device of the multi-display device. Here, a time difference between a vertical synchronization signal of an original image and a vertical synchronization signal input to each display module of the corresponding multi-display device is checked in advance to set a delay time for synchronizing the input of the image signal at the delay setting unit 120, and the image signal is delayed as much as the delay time value set in the delay setting unit 120 by the signal input controller 110 at each display device and then input to the display module 300. By doing so, image signals are simultaneously input to the display module 300 of all display devices of the corresponding multi-display device without a time difference, which allows all display devices to display images on the screen without a time difference.

By measuring a timing of a vertical synchronization signal input to each display module 300 of the multi-display device, an image signal input time difference between the vertical synchronization signals of each display module 300 and the original image may be checked. In order to synchronize the input of image signals to all display modules, based on a display module to which an image signal is input most slowly, time differences of image signals input to other display modules are quantized into digital values and set as a delay time value in the delay setting unit 120 through a separate device.

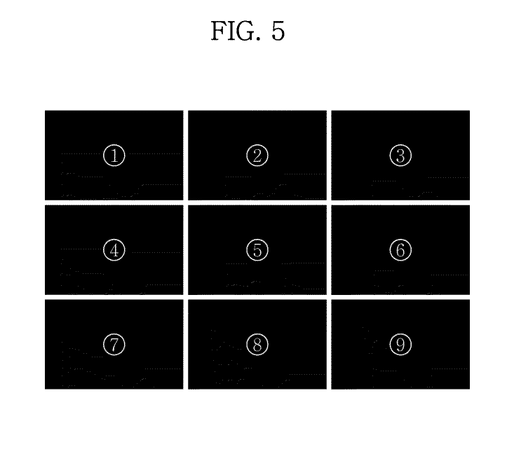

For example, as shown in FIG. 5, in case of implementing a display screen of a multi-display device using 3×3 display devices (1^{st} to 9^{th} display devices), all display devices identically receive original image signals input from an image source, then enlarge the original image signals into an image according to an entire multi-display configuration, and display individual images in their regions on the enlarged image.

In more detail, the multi-display device determines an entire multi-display configuration (M×N) according to a control signal input from the outside, and the control signal is, for example, transmitted to or received from a control controller (e.g., PC) using communication standards such as RS232C or Ethernet. In addition, each display device has location information according to its installation location. For example, in a 3×3 configuration, identifiers (ID) corresponding to the 1^{st} to 9^{th} display devices should be set for individual display devices, and this is set when a user manipulates a switch included in each display device. By doing so, the display device may figure out its configuration and location, and if the original image is received, the display device checks the entire multi-display configuration information (M×N) and a region corresponding to its location information (ID) and then displays an enlarged image.

Here, the process of receiving an original image, enlarging the original image and processing the enlarged image into an image of a corresponding region is performed by the image processor 200 in the display device. The image signal processed by the image processor 200 is transmitted again to the display module 300 in the display device and displayed as an image.

At this time, a time delay occurs between the vertical synchronization signal of the original image input to the image processor 200 and the vertical synchronization signal input to the display module 300. This phenomenon happens at each display device, which results in distortion of a contour of a vertical scroll bar image of display devices in an entire image when configuring a multi-display device.

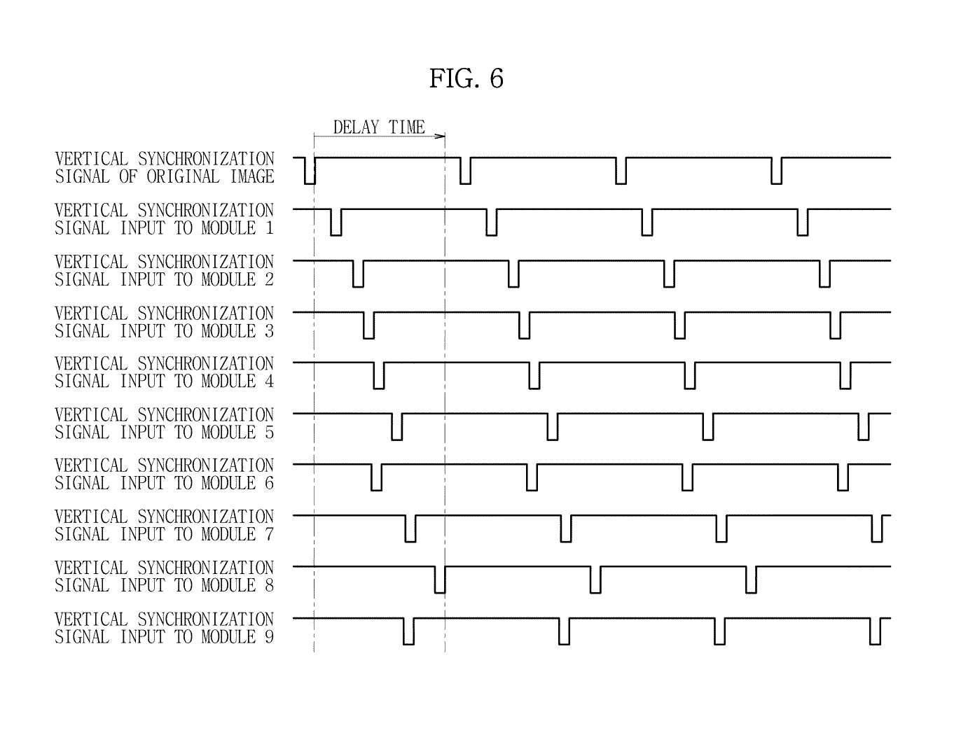

As shown in FIG. 6, after a time difference between a vertical synchronization signal of an original image input to each display device and a vertical synchronization signal input to each display module is measured, the time difference is compared with a time difference of a display module having the greatest time difference. After that, a difference between the time difference of each display module and the greatest time difference is set as a delay time value and stored in the delay setting unit 120.

In more detail, with reference to FIG. 6, assuming that the display device operates with 60 Hz for example, the vertical synchronization signal repeats with an interval of 16.67 ms. At this time, assuming that a module 8 having the greatest delay time difference in comparison to the original image signal has a time difference of 10 ms and a module 1 having the smallest time difference has a time difference of 2 ms, the delay time value of the module 1 is set as 8 ms. In the same way, the delay time value of each display device is set, and in operation, the image signal is delayed as much as the corresponding delay time value by the signal input controller 110 and input to the display module 300. In this delay time value setting method, driving timings of all display modules are synchronized based on the vertical synchronization signal of a display module which is input most slowly in comparison to the vertical synchronization signal of the original image.

As another embodiment, after a time difference between a vertical synchronization signal of an original image input to each display device and a vertical synchronization signal input to each display module is measured, a value obtained by subtracting the measured value from an interval of the vertical synchronization signal of the original image may also be set as a delay time value.

For example, assuming that the display device operates with 60 Hz based on FIG. 6, the vertical synchronization signal repeats at an interval of 16.67 ms. Here, assuming that a module 8 having the greatest delay time difference in comparison to the original image signal has a time difference of 10 ms and a module 1 having the smallest time difference has a time difference of 2 ms, the driving timing of the module 8 may be additionally delayed by 6.67 ms to conform to a next signal of the vertical synchronization signal of the original image. In this case, the delay value is set so that the driving timing of the module 1 operates after being delayed by 14.67 ms and other display modules are also synchronized with the next vertical synchronization signal of the original image signal to operate simultaneously. In this delay time value setting method, a vertical synchronization signal input to a module of each display is synchronized with a next vertical synchronization signal of the original image.

Moreover, in addition to two delay value setting methods described above, various other methods may also be used to set a delay value as long as vertical synchronization signals of all display modules may be synchronized.

In this way, image signals input to the 1^{st} to 9^{th} display modules are synchronized and simultaneously input to the 1^{st} to 9^{th} display modules without a time difference so that the 1^{st} to 9^{th} display modules may simultaneously display images on the screen without a time difference.

Next, a method for setting and storing the delay value will be described. In case of setting a delay time at the delay setting unit 120, a delay time value according to a location of each display device which configures a screen of the multi-display device is stored in a form of a look-up table. In more detail, all delay time values of individual display devices according to location (ID) of the display devices which belong to the corresponding to multi-display device having a multi-display configuration (M×N, for example, 2×2, 3×3, 4×4, 3×2, 4×3, or the like) and configure a screen are stored in the delay setting unit 120 in a table form. For example, in FIG. 5, the delay time values are stored in a table form including the entire multi-display configuration information (M×N), expressed as (3×3), the identifier (ID) for identifying locations of the 1^{st} to 9^{th} display devices, and time delay values of the corresponding 1^{st} to 9^{th} display devices. Similarly, with respect to other multi-display configurations (M×N) (for example, 2×2, 4×4, 3×2, 4×3, or the like), all delay time values of individual display devices according to the locations (ID) of the display devices belonging to the corresponding to the multi-display device and configuring a screen are stored in the delay setting unit 120 in a table form.

Based on this, in operation, when an image signal is received from the image processor 200, the signal input controller 110 stores the corresponding image signal in the storage unit 130, reads a corresponding delay time value from the delay setting unit 120, based on the entire multi-display configuration (M×N) and the identifier (ID) for identifying a location of the corresponding display device belonging thereto, which are included in the corresponding image signal, and then outputs the image signal to the display module 300 after delaying by the corresponding time delay value.

In addition, even though it has been described that the delay time value of the vertical synchronization signal is directly measured and stored in the delay setting unit 120 in a table form, in the case where time delay values of vertical synchronization signals according to the entire multi-display configuration (M×N) of the multi-display device and the locations (ID) of display devices belonging thereto have a regular pattern, the time delay values may also be calculated and stored in the delay setting unit 120 in a table form.

The apparatus 100 for buffering a signal delay between display devices is individually installed at each display device of the multi-display device, and each display device is provided with the image processor 200 and the display module 300.

In the case the image processor 200 processes and outputs an image signal received from the outside, the signal input controller 110 employed in the apparatus 100 for buffering a signal delay between display devices controls an input of the image signal from the image processor 200 to the display module 300. Here, the signal input controller 110 stores the image signal output from the image processor 200 in the storage unit 130, and then inputs the image signal to the display module 300 after delaying by the delay time value set in the delay setting unit 120.

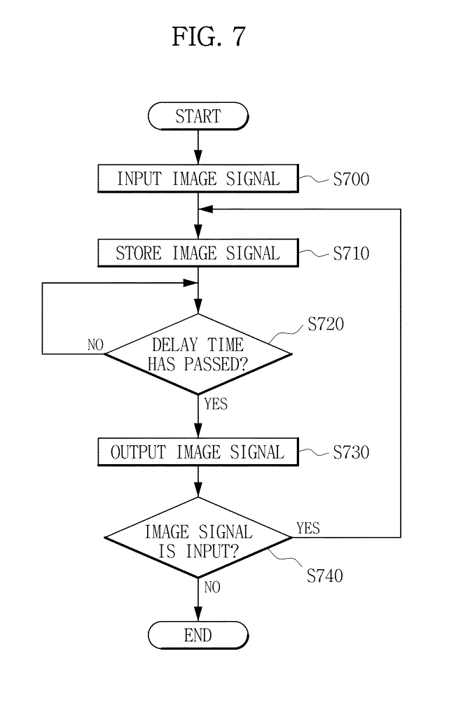

In the apparatus 100 for buffering a signal delay between display devices in a multi-display environment according to the present disclosure as described above, an input delay of an image signal to each display module is buffered as shown in FIG. 7.

First, if an image signal is input from the image processor 200 (S700), the signal input controller 110 stores the corresponding image signal in the storage unit 130 (S710).

In addition, the signal input controller 110 checks whether a delay time set in the delay setting unit 120 has passed. At this time, the signal input controller 110 checks whether the corresponding delay time has passed by reading a corresponding delay time value from the delay setting unit 120 based on the entire multi-display configuration (M×N) and the identifier (ID) for identifying a location of a display device belonging thereto (S720). If it is checked that the delay time has passed, the signal input controller 110 reads the corresponding image signal stored in the storage unit 130 and outputs the image signal to the display module 300 (S730).

After that, the signal input controller 110 checks whether an image signal is input from the image processor 200 (S740). If an image signal is input, the process returns to S710 to repeat the above procedure. If an image signal is not input, the process ends.

As described above, the apparatus 100 for buffering a signal delay between display devices synchronizes image signals input to display modules belonging to display devices of a multi-display device and simultaneously inputs image signals to the display modules without a time difference, thereby allowing all display modules to display images simultaneously on the screen without a time difference.

Therefore, since the present disclosure buffers an image signal input time difference of all display devices to offset a display time difference of the display devices in a multi-display environment where a display screen is implemented using a plurality of display devices, it is possible to prevent image quality from deteriorating due to the display time difference between the display devices.

The present disclosure is not limited to the above, but any person skilled in the art can modify the present disclosure in various ways without departing from the spirit of the present disclosure, and such modifications should be regarded as falling within the scope of the present disclosure.

The present disclosure may be usefully applied when a multi-display device is implemented using a plurality of display devices. According to the present disclosure, in a multi-display environment where a display screen is implemented using a plurality of display devices, an image signal input time difference of all display devices is buffered to offset a display time difference of the display devices. Therefore, it is possible to prevent image quality from deteriorating due to the display time difference between the display devices.

1. An apparatus for buffering a signal delay between display devices in a multi-display environment, which buffers an image signal input time difference of display devices with respect to a display module in a multi-display environment where a display screen is implemented using a plurality of display devices, the apparatus comprising:
a delay setting unit for storing a delay time value and providing the delay time value to a signal input controller;
a storage unit for storing and outputting an image signal according to the control of the signal input controller; and
the signal input controller for controlling an input of an image signal from an image processor to a display module, the signal input controller controlling the image signal input from the image processor to be stored in the storage unit and then input to the display module after a delay as much as the delay time value.

2. The apparatus for buffering a signal delay between display devices in a multi-display environment according to claim 1,
wherein the storage unit includes a volatile memory including a synchronous dynamic random access memory (SDRAM).

3. The apparatus for buffering a signal delay between display devices in a multi-display environment according to claim 1,
wherein the delay setting unit stores the delay time value in a table form including configuration information (M×N) of the entire multi-display device, an identifier (ID) for identifying a location of a display device belonging thereto, and a time delay value of the corresponding display device.

4. The apparatus for buffering a signal delay between display devices in a multi-display environment according to claim 1,
wherein the signal input controller reads a corresponding delay time value from the delay setting unit based on the configuration information (M×N) of the entire multi-display device and the identifier (ID) for identifying a location of a display device belonging thereto, included in the control signal input to the image processor, and delays the image signal as much as the corresponding time delay value.

5. The apparatus for buffering a signal delay between display devices in a multi-display environment according to claim 3,
wherein the signal input controller reads a corresponding delay time value from the delay setting unit based on the configuration information (M×N) of the entire multi-display device and the identifier (ID) for identifying a location of a display device belonging thereto, included in the control signal input to the image processor, and delays the image signal as much as the corresponding time delay value.

6. The apparatus for buffering a signal delay between display devices in a multi-display environment according to claim 1,
wherein after measuring a time difference between a vertical synchronization signal of an original image input to each display device and a vertical synchronization signal input to each display module, then comparing the time difference with a time difference of a display module having the greatest time difference, the delay time value is set as a difference between the time difference of each display module and the greatest time difference.

7. The apparatus for buffering a signal delay between display devices in a multi-display environment according to claim 1,
wherein after measuring a time difference between a vertical synchronization signal of an original image input to each display device and a vertical synchronization signal input to each display module, the delay time value is set as a value obtained by subtracting the measured value from an interval of the vertical synchronization signal of the original image.

8. The apparatus for buffering a signal delay between display devices in a multi-display environment according to claim 1,
wherein when a time difference between a vertical synchronization signal of an original image input to the plurality of display devices and a vertical synchronization signal input to each display module has a regular pattern, the regular pattern is calculated and compared with a time difference of a display module having the greatest time difference, and the delay time value is set as a difference between the time difference of each display module and the greatest time difference.

9. The apparatus for buffering a signal delay between display devices in a multi-display environment according to claim 1,
wherein when a time difference between a vertical synchronization signal of an original image input to the plurality of display devices and a vertical synchronization signal input to each display module has a regular pattern, the regular pattern is calculated, and the delay time value is set as a value obtained by subtracting the calculated value from an interval of the vertical synchronization signal of the original image.

10. A method for buffering a signal delay between display devices in a multi-display environment, which buffers an image signal input time difference of display devices with respect to a display module in a multi-display environment where a display screen is implemented using a plurality of display devices, the method comprising:
controlling, by a signal input controller, an image signal input from an image processor to be stored in a storage unit;
checking, by the signal input controller, whether a delay time set in a delay setting unit has passed; and
reading, by the signal input controller, the image signal stored in the storage unit and outputting the image signal to a display module when the delay time has passed.

11. The method for buffering a signal delay between display devices in a multi-display environment according to claim 10, wherein said checking of whether a delay time set in a delay setting unit has passed includes:
checking, by the signal input controller, configuration information (M×N) of the entire multi-display device and an identifier (ID) set to identify a location of a display device belonging thereto, included in a control signal input to the image processor; and
reading, by the signal input controller, a delay time value corresponding to the configuration information (M×N) and the identifier (ID) from the delay setting unit.
